(19) United States
(12) Patent Application Publication
(10) Pub. No.: US 2019/0133140 A1
(43) Pub. Date: May 9, 2019

(54) DOUGH PROCESSING ASSEMBLY

(71) Applicant: MINIPAN S.R.L., Massa Lombarda (IT)

(72) Inventors: Franco FUSARI, Misano Adriatico (IT); Bruno FUSARI, Bagnacavallo (IT)

(21) Appl. No.: 16/175,136

(22) Filed: Oct. 30, 2018

(30) Foreign Application Priority Data
Nov. 6, 2017 (IT) 102017000125578

(51) Int. Cl. A21C 9/08; A21C 1/14

(52) U.S. Cl. CPC A21C 9/088; A21C 1/1435

(57) ABSTRACT

A dough processing assembly includes a fixed frame, an entry area and an exit area for the dough subjected to the processes. The assembly includes at the entry area, a station for loading predefined quantities of dough in a receptacle. The assembly further includes at least one first conveyor belt, arranged downstream of the receptacle and adapted to receive and translate the dough; and at least one second conveyor belt, which is perpendicular and arranged below the first belt, for receiving the dough from the first belt. The assembly includes a station for dispensing the dough, at the exit area, provided with elements for folding the dough onto itself, for the juxtaposition of contiguous surfaces thereof so as to form configurations of the type of a layering, of a roll, and the like.

### CROSS-REFERENCE TO RELATED APPLICATIONS

This application is related to and claims the benefit of Italian Patent Application No. 102017000125578, filed on Nov. 6, 2017, the contents of which are herein incorporated by reference in their entirety.

### TECHNICAL FIELD

The present disclosure relates to a dough processing assembly, particularly suitable for processing doughs with a high content of water, therefore with a sticky behavior and without a consolidated shape.

### BACKGROUND

A dough that is particular rich in water must be provided in order to produce some specific types of bakery products.

In particular, this type of dough is used to produce focaccias, baguettes and other very widely used types of bread.

In order to obtain a finished product with the best organoleptic characteristics and the correct segregation of air bubbles (optimum rising), the dough must undergo some processes intended for the correct forming of the so-called gluten matrix.

The long protein chains, held together by bonds between two sulfur atoms (disulfide bridges) which form between individual protein molecules, must be arranged so as to create a matrix (gluten matrix) that ensures the segregation of the gaseous bubbles that are generated during rising and which, during baking, will force the bakery product to swell.

The dough must be folded onto itself one or multiple times along at least one first direction: more often, the dough is folded onto itself or rolled up along at least two mutually perpendicular directions in order to generate a matrix with fine and uniform mesh.

This process is normally performed manually (in a handcrafted manner) and requires, especially for important dough volumes, the simultaneous intervention of multiple operators. The high percentage of water that is present in the dough makes it very sticky and increases the difficulty of the operations that must be performed by the operators.

In the case of large-scale productions, it is necessary to provide for different teams of operators to perform the operations for folding the dough in different stations, in order to provide a continuous supply of dough to the subsequent stations for the forming of the products and for their baking.

### SUMMARY

The aim of the present disclosure is to solve the problems described above, proposing a dough processing assembly that is suitable to fold onto themselves even doughs containing very large percentages of water.

Within this aim, the disclosure proposes a dough processing assembly that ensures the forming of a dense gluten matrix in the dough itself.

The disclosure also proposes a dough processing assembly that can process even large masses of dough at a time.

The present disclosure provides a dough processing assembly that has low costs, is relatively simple to provide and is safe in application.

This aim and these and other advantages that will become better apparent hereinafter are achieved by providing a dough processing assembly comprising a fixed frame, an entry area and an exit area for the dough subjected to said processes, comprising:
at said entry area, a station for loading predefined quantities of dough in a receptacle,
at least one first conveyor belt, arranged downstream of said receptacle and adapted to receive and translate said dough,
at least one second conveyor belt, which is perpendicular and arranged below said first belt, for receiving said dough from said first belt, and
a station for dispensing said dough, at said exit area, provided with means for folding said dough onto itself, for the juxtaposition of contiguous surfaces thereof so as to form configurations similar to a layering, a roll, and the like.

### BRIEF DESCRIPTION OF THE DRAWINGS

Further characteristics and advantages of the disclosure will become better apparent from the description of a preferred but not exclusive embodiment of the dough processing assembly according to the disclosure, illustrated by way of non-limiting example in the accompanying drawings, wherein:

FIG. 1 is a first perspective view of a dough processing assembly according to the disclosure;

FIG. 2 is a second perspective view of the assembly of FIG. 1;

FIG. 3 is a partially sectional side view of the assembly of FIG. 1; and

FIG. 4 is a partially sectional front view of the assembly of FIG. 1.

### DETAILED DESCRIPTION OF THE DRAWINGS

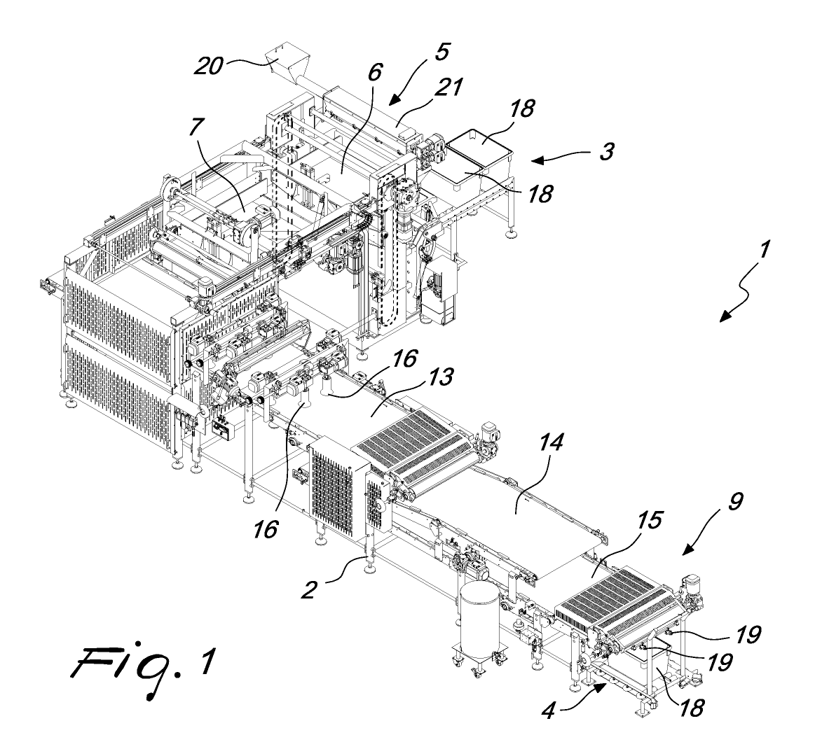

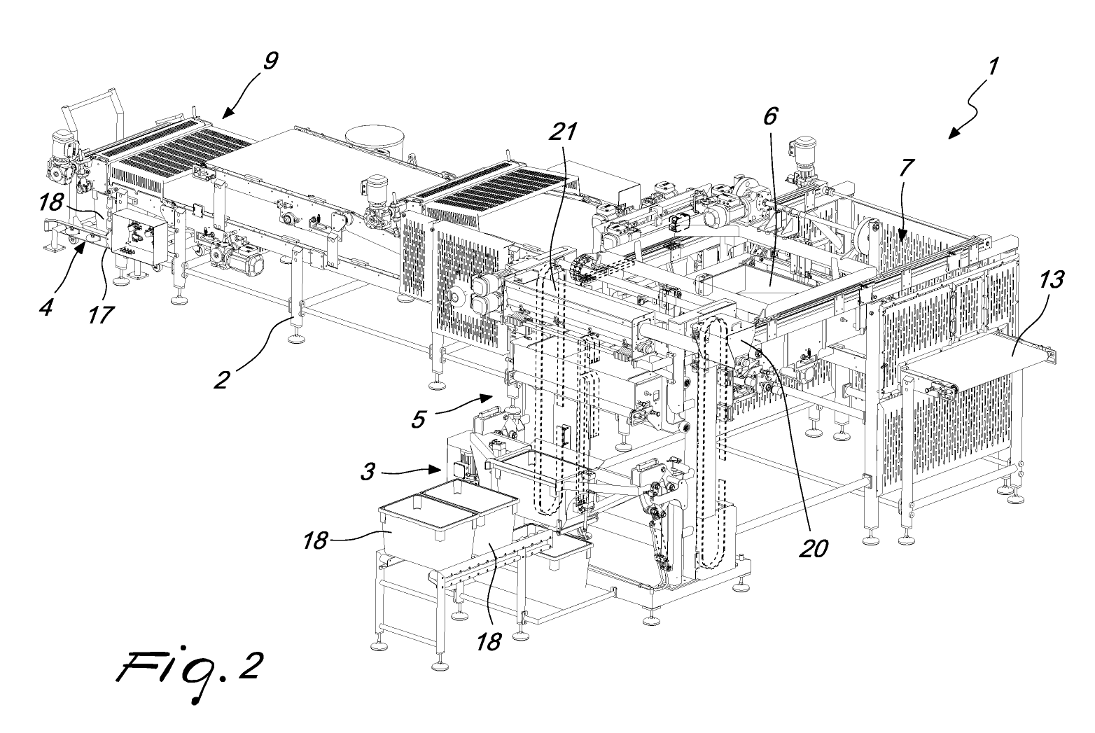

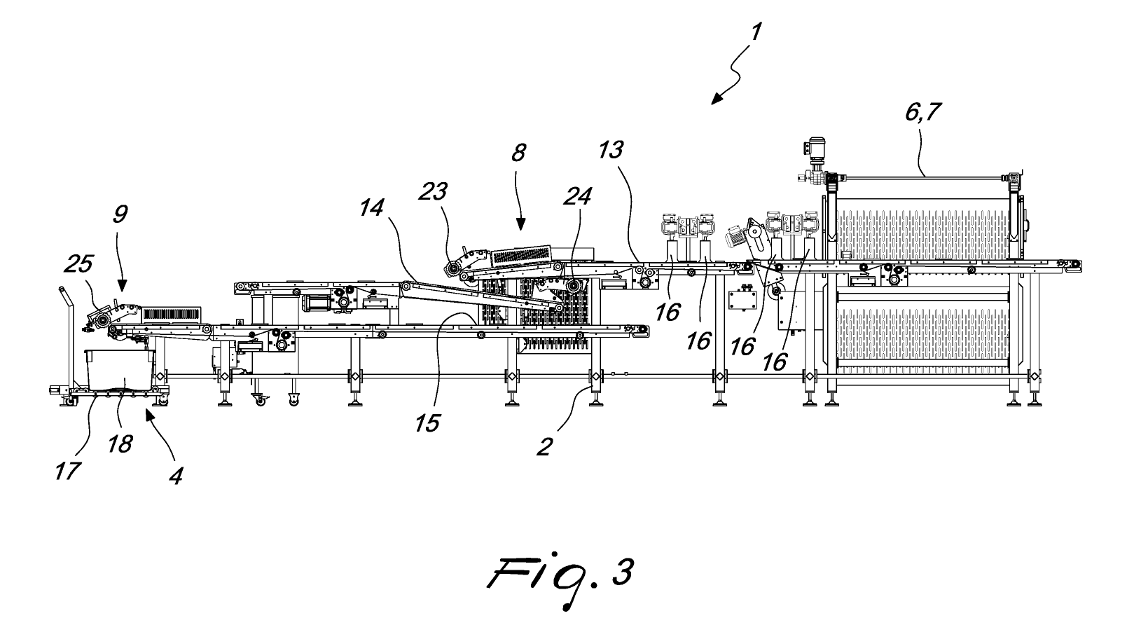

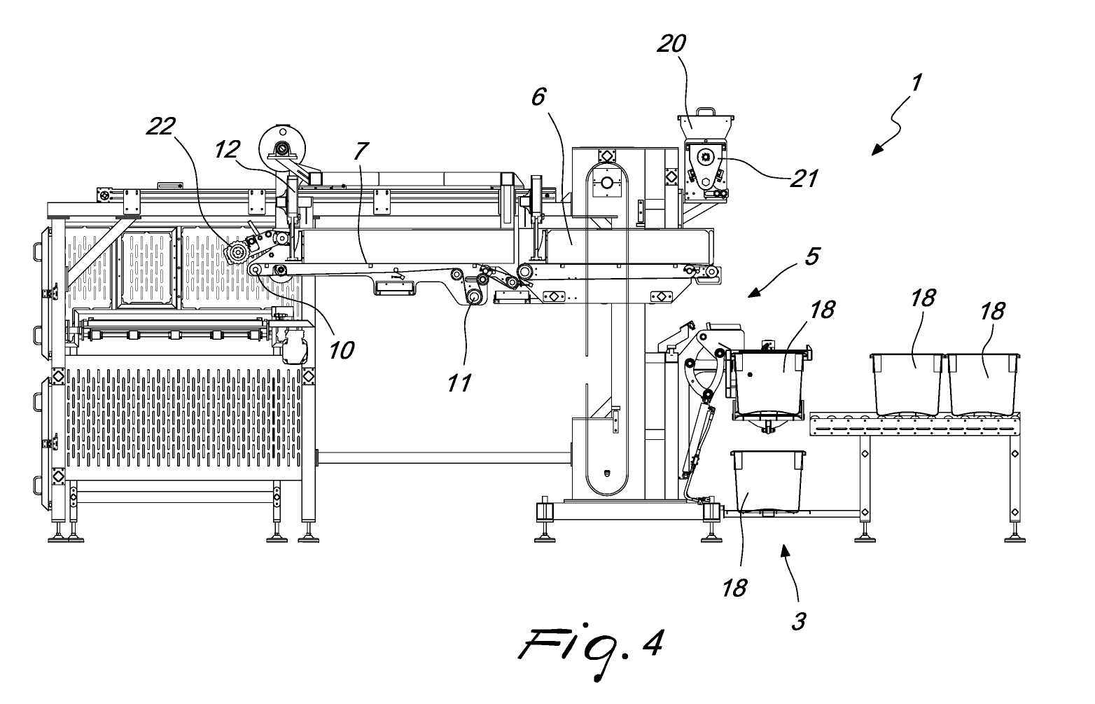

With particular reference to FIGS. 1-4, the reference numeral 1 generally designates a dough processing assembly according to the disclosure.

The dough processing assembly 1 comprises a fixed frame 2, a dough entry area 3 and an exit area 4 for the dough subjected to the above-cited processes. The assembly 1, at the entry area 3, comprises a station 5 for loading predefined quantities of dough in a receptacle 6.

The receptacle 6, according to a preferred embodiment, is formed between respective containment walls, at least one of which is movable.

At least one first conveyor belt 7 is arranged downstream of the movable wall of the receptacle 6 and is adapted to receive and translate the dough.

Actually, the base surface of the receptacle 6 also is constituted by a conveyor belt unit: the removal of the movable wall allows the conveyor belt unit to transfer the dough to the at least one first belt 7. The different travel speed of the conveyor belt unit with respect to the at least one first belt 7 produces a stretching of the dough, which therefore elongates in the traction direction, facilitating a substantially directional arrangement of the gluten chains that are present in the dough.

The assembly 1 furthermore comprises at least one second conveyor belt, which is perpendicular and arranged below the first belt 7, for receiving the dough from the first belt 7.

A terminal station 9 for dispensing the dough (after the assembly 1 has subjected it to the appropriate processes), at the exit area 4, is provided with means for folding the dough onto itself, for the juxtaposition of contiguous surfaces thereof socially fine configurations such as a layering, a roll, and the like.

In practice, the dough folding means are designed to layer and/or roll up the dough (appropriately stretched along a specific direction), so that its external surfaces are progressively juxtaposed: the layering and/or rolling ensure that the gluten protein chains in the dough are superimposed, defining an ordered three-dimensional distribution thereof which generates the gluten matrix required for correct rising and baking of the bakery product that will be provided by means of said dough.

With particular reference to an embodiment of unquestionable interest in practice and in application, the at least one first conveyor belt 7 is supported by specific brackets, which in turn can move with respect to the fixed frame 2; the first belt 7 is furthermore provided with a movable end roller 10, which allows it to change its own length, allowing a movement of its terminal end (forward and backward) along the direction of advancement of the dough on said belt 7.

The movable end roller 10 is actuated by respective first actuators and the variation of the length of the useful surface of the first belt 7, designed to convey the dough, is ensured by the presence of a buffer at which the belt 7 is bent along a predefined path of variable extent. The variation of the extent of the path defined by the buffer is achieved by virtue of the presence of an additional roller 11 for guiding the belt 7, which is conveniently movable along a predefined stroke (actuated by elastic means or by pushers controlled by the same control and management unit that controls the movement of said end roller 10).

The brackets can move with respect to the frame 2 by means of respective second actuators 12 in order to vary the height of the belt 7 (in particular of its terminal end), with a consequent variation of its distance from the second conveyor belt 8.

The combination of the motion imparted by the first and second actuators 12 allows to deliver the dough onto the surface of the second conveyor belt 8 in a layered configuration, with related folded external surfaces, so as to mutually fit together.

Furthermore, it is specified that by analyzing an embodiment of unquestionable effectiveness, the at least one second conveyor belt 8 preferably comprises a plurality of moving belts 13, 14 and 15 which are arranged in a cascade.

The moving belts 13, 14 and 15 have progressively increasing travel speeds in order to generate at the same time translation and stretching, which includes an elongation along a predefined direction, of the dough. The different speeds of the moving belts 13, 14 and 15 in fact entail that the dough is entrained by the downstream belt (14 or 15) faster than the speed with which it arrives from the upstream belt (respectively 13 or 14): this produces a stretching of the dough which tends to flatten and elongate in the advancement direction. This elongation along a predefined direction contributes to an alignment/ordering of the gluten protein chains.

With particular reference to the constructive embodiment shown in the accompanying figures, the belt 13 is the one that is at the greatest height and is partially surmounted (at its initial region) by the first conveyor belt 7.

Multiple conveyance rollers 16 with a preferably vertical axis are arranged along the belt 13: these rollers 16 about against the lateral surfaces of the dough that is present on the belt 13, preventing it from being able to expand in terms of width. If one operates on considerable dough masses (for example weighing several tens of kilograms), transverse expansion of the dough (caused by the effect of its own weight) might even make it spill beyond the edges of said belt 13: the conveyance rollers 16 prevent the occurrence of this condition, which would compromise the correct operation of the entire assembly.

The movable belt 14 is instead arranged below the belt 13, inclined with respect to it and directed backward: this particular arrangement allows to use the decrease in conveyance height to subject the dough to further stretching, all with a considerable containment of space occupation, since the belt 13 is juxtaposed against a portion of the belt 14, minimizing the overall longitudinal space occupation. Furthermore, it is specified that the means for folding the dough onto itself, comprised in the exit area 4, comprise a support 17 which can slide along the direction of the terminal portion of the at least one second belt 8 (in particular the terminal portion of the belt 15).

By means of the translation of a container 18, arranged on the support 17, with an alternating motion along a predefined stroke during the dispensing of the dough from the belt 15, storage of said dough in the container 18 is caused so that it is arranged with folded and juxtaposed surfaces.

In greater detail, if one adjusts the (forward-backward) oscillation speed of the container 18 on the sliding support 17, according to a stroke that is equal to the length of said container 18, as a function of the exit speed of the dough from the belt 15, it is possible to deposit a first layer of dough onto the bottom of the container 18 and then, by reversing the motion of the container 18, superimpose a second layer on the first layer. By repeating this operation until the dough on the belt 15 has ended, it is thus possible to store the dough in the container 18 with a configuration that ensures the forming of a gluten matrix (of the gluten protein chains) that is particularly regular and evenly distributed in the dough volume.

The movement of the container 18 on the support 17 can be entrusted for example to an operator who manually handles the oscillation of the container 18 during the dispensing of the dough from the belt 15.

According to a completely automatic constructive solution, the support 17 for the container 18 might instead be advantageously able to slide and translate by virtue of the action of respective actuators.

In this case, a specific control and management unit is designed to control these actuators, in order to adjust their stroke and their rule of motion, as a function of the exit speed of the dough from the belt 15.

With particular reference to a constructive solution which is alternative to the one described previously, the means for folding the dough onto itself comprised in the exit area 4 may favorably comprise a collection carousel, for rolling up onto itself the dough dispensed by the terminal portion of the at least one second belt 8 (in particular the terminal portion of the belt 15) and delivering it into a collection container 18 arranged proximate to the carousel.

Rolling up can be obtained by means of a roller which lifts the initial end of the dough that arrives from the belt 15 and tips it on to the top of the dough that is contiguous thereto, proceeding with this operation as the dough advances until it has been rolled up completely, generating a block of dough that has a substantially cylindrical shape (more correctly, barrel-shaped).

At this point, by means of an ordinary pick and place device it is possible to pick up the block of rolled up dough and deliver it in a container 18 which is arranged proximate to the exit area 4.

It is useful to specify that the terminal portion of the at least one second belt 8 (in particular the terminal portion of the belt 15) can conveniently comprise nozzles 19 for dispensing a liquid chosen preferably from water, oil, emulsion of water and oil, water comprising substances chosen from flavorings, coloring agents, preservatives, raising agents and additives in general, and oil comprising substances chosen from flavorings, coloring agents, preservatives, raising agents and additives in general.

During the layering of the dough in the container 18 and/or during the rolling of the dough onto itself, the nozzles 19 atomize the liquid, which may have multiple purposes.

First of all, the liquid may contribute to a further hydration of the dough or to an addition of oil, in accordance with the requirements and the recipe of the product that must be provided with said dough.

In some cases, the liquid can contribute to change the characteristics of the dough, which will cause a consequent modification of the organoleptic characteristics and/or of the appearance and/or of the rising of the finished product that will be provided with said dough.

It is specified furthermore that the assembly 1 comprises at least one hopper 20 for containing a powdery substance chosen among flour, semolina, starch and the like. It is not excluded that the powdery substance may also comprise flavoring additives, preservatives, coloring agents, raising agents and other kinds of additives.

The hopper 20 is connected to elements 21 for the uniform distribution of the substance on at least one portion of a respective belt, chosen between the at least one first belt 7 and the at least one second belt 8 (in particular at least one of the belts 13, 14 and 15).

The distribution of flour, semolina or other powdery substances on the belts 7 and 8 (belts 13, 14 and 15) facilitates the separation of the dough from them and therefore allows the assembly 1 to operate for long operating periods without requiring maintenance and/or cleaning activities.

The nozzles 19 are therefore useful also to restore the correct rate of humidity in the dough, which is modified by the adhesion of the flour, which is present on the various conveyors, to its external surfaces.

With reference to a particularly productive and advanced constructive solution, it is pointed out that between the initial loading station 5 and the exit area 4 it is possible to provide advantageously a line for the automatic conveyance of containers 18.

Such line deals with the pickup of the containers 18 emptied of the dough in the initial loading station 5 and their transfer to the exit area 4 to receive the dough appropriately folded onto itself.

In this regard, it is specified that the containers 18 may reach the initial loading station 5 appropriately arranged in a row on a conveyance lane. A pickup apparatus of the station 5 can then grip a respective container 18 (the first one of the row, i.e., the one closest to the station 5), lift it to a preset level at which it surmounts the receptacle 6, and tip its content into said receptacle.

The speed of the operation and the retention of the container 18 in the tipped arrangement above the receptacle 6 are determined by the particular type of dough and by the corresponding content of water (for example a highly hydrated dough is stickier and therefore will tend to adhere to the container 18, thus requiring more time for complete exit from it). Furthermore, it is deemed useful to specify that lobe-type rollers 22, 23, 24 and 25 are arranged downstream of each belt 7 and 8 (in particular downstream of each belt 13, 14 and 15).

The particular shape of the lobe-type rollers 22, 23, 24 and 25, the possibility to adjust their distance from the surface of the respective belt 7, 8) (belt 13, 14 and 15), as well as the optional motorization of the lobe-type rollers 22, 23, 24 and 25, will ensure a mechanical action on the dough, which can be likened to a massage which facilitates the relaxation of any internal tensions of the gluten protein chains.

Advantageously, the present disclosure solves the problems described previously, proposing a dough processing assembly 1 which is suitable to fold onto themselves even doughs that contain very high percentages of water.

The particular shape of the components of the assembly 1 and the presence of elements for the lateral containment of the dough, as well as of the dispensers of powders (such as flour, semolina and the like) allow to manage easily even doughs that are particularly rich in water and therefore have a sticky behavior and lack a definite shape.

Efficiently, the assembly 1 according to the disclosure ensures the forming of a dense gluten matrix in the dough.

The subsequent folds that the assembly 1 provides on the dough are such as to ensure optimum distribution of the gluten protein chains. Positively, the assembly 1 according to the disclosure can also process large masses of dough at a time. Validly, the present disclosure provides a dough processing assembly that is relatively simple to provide in practice and has low costs: the assembly according to the disclosure constitutes an improvement of assured application.

The disclosure thus conceived is susceptible of numerous modifications and variations, all of which are within the scope of the appended claims; all the details may furthermore be replaced with other technically equivalent elements.

In the shown embodiments, individual characteristics, given in relation to specific examples, may actually be interchanged with other different characteristics of other examples of embodiment.

In practice, the materials used, as well as the dimensions, may be any according to the requirements and the state of the art.

1. A dough processing assembly comprising a fixed frame, an entry area and an exit area for the dough subjected to processing, the assembly comprising:
at said entry area, a station for loading predefined quantities of dough in a receptacle,
at least one first conveyor belt, arranged downstream of said receptacle and adapted to receive and translate said dough,
at least one second conveyor belt, which is perpendicular and arranged below said first belt, for receiving said dough from said first belt, and
a station for dispensing said dough, at said exit area, provided with means for folding said dough onto itself, for the juxtaposition of contiguous surfaces thereof so as to form configurations.

2. The assembly according to claim 1, wherein said at least one first conveyor belt is movable, with respect to said fixed frame, by means of respective first actuators along at least one first direction which is parallel to a direction along which the dough advances on said first belt.

3. The assembly according to claim 2, wherein said at least one first conveyor belt is movable, with respect to said fixed frame, by means of respective second actuators for varying its own height, with consequent variation of its distance from said second conveyor belt, the combination of the motion imposed by the first and second actuators allowing a delivery of said dough onto the surface of said second conveyor belt in a layered configuration, with corresponding external surfaces which are folded, fitted together and juxtaposed.

4. The assembly according to claim 1, wherein said at least one second conveyor belt comprises a plurality of moving belts in a cascade which have progressively increasing travel speeds for the translation and stretching, which includes an elongation along a predefined direction, of said dough.

5. The assembly according to claim 1, wherein said means for folding said dough onto itself, comprised in said dispensing station, comprise a support which can slide along a direction of a terminal portion of said at least one second belt, the translation of a container, arranged on said support, with an alternating motion along a predefined stroke, during the dispensing of the dough, causing a storage thereof with folded and juxtaposed surfaces.

6. The assembly according to claim 5, wherein said support for said container can slide and translate by virtue of the action of respective actuators, a respective control and management unit actuating said actuators for the adjustment of their stroke and of their rule of motion.

7. The assembly according to claim 1, wherein said means for folding said dough onto itself, comprised in said dispensing station, comprise a collection carousel for rolling up the dough dispensed by said terminal portion of said at least one second belt and for delivering the dough in a collection container arranged proximate to said carousel.

8. The assembly according to claim 5, wherein said terminal portion of said at least one second belt comprises nozzles for dispensing a liquid chosen from water, oil, emulsion of water and oil, water comprising substances chosen from flavorings, coloring agents, preservatives and additives, and oil comprising substances chosen from flavorings, coloring agents, preservatives and additives.

9. The assembly according to claim 4, further comprising at least one hopper for the containment of a powdery substance, said at least one hopper being connected to elements for a uniform distribution of said substance on at least one portion of a respective belt, chosen between said at least one first belt and at least one second belt.

10. The assembly according to claim 1, wherein between said station for loading predefined quantities of dough and said dispensing station for dispensing said dough there is a line for automatic conveyance of containers, for the pickup of the containers emptied of the dough in said station for loading and their transfer into the terminal dispensing station for receiving the dough appropriately folded onto itself.
